(19) United States
(12) Patent Application Publication
(10) Pub. No.: US 2024/0342970 A1
(43) Pub. Date: Oct. 17, 2024

(54) INJECTION MOLDING TOOLING TOOL, CLEANING METHOD FOR AN INJECTION MOLDING TOOLING TOOL AND INJECTION MOLDING METHOD

(71) Applicant: MHT Mold & Hotrunner Technology AG, Hochheim (DE)

(72) Inventors: Christian WAGNER, Mainz (DE); Peter SÜSS, Messel (DE); Thomas GEBAUER, Weiskirchen Saar (DE); Christian TILSNER, Weiterstadt (DE)

(73) Assignee: MHT Mold & Hotrunner Technology AG, Hochheim (DE)

(21) Appl. No.: 18/632,674

(22) Filed: Apr. 11, 2024

(30) Foreign Application Priority Data
Apr. 14, 2023 (DE) 102023109494.7

(51) Int. Cl. B29C 45/17; B29C 45/26; B29C 45/33

(52) U.S. Cl. CPC B29C 45/1753; B29C 45/2602; B29C 45/2608; B29C 45/33

(57) ABSTRACT

An injection molding tool or an injection method for producing at least one molded part in a molding space, wherein the injection molding tool has at least two tool elements which are movable relative to one another between an open position and a closed position, wherein in the closed position the molding space is at least partially enclosed by the at least two tool elements and wherein in the open position a molded part produced in the molding space can be removed from the injection molding tool. In order to enable cleaning of the injection molding tool, a cleaning position is provided which lies between the open position and the closed position and in which a spacer element is arranged between the tool elements.

### FIELD OF THE DISCLOSURE

The present invention relates to an injection molding tool for producing at least one molded part in a molding space, wherein the injection molding tool has at least two tool elements which can be moved relative to one another between an open position and a closed position, wherein in the closed position the molding space is at least partially enclosed by the at least two tool elements, and wherein in the open position a molded part produced in the molding space can be removed from the injection molding tool.

The present invention also relates to a cleaning method for an injection molding tool of the type mentioned above and to an injection molding method for producing a molded part with an injection molding tool of the type mentioned above.

### BACKGROUND

Injection molding is one of the most important processes for manufacturing plastic molded parts. The molding compound, which is generally originally in powder or granulate form, is heated, plasticized and pressed as a plasticized melt under high pressure into a molding space of a corresponding molding tool. The molding compound solidifies in the molding tool and is then removed from the open tool as a molded part. The molded part can be a finished molded part or a preform, which is then reworked in further process steps. For example, commercially available PET bottles are produced by stretch blow molding a hollow preform.

To produce a molded part, an injection molding tool typically has a cavity plate with at least one cavity and a core plate with at least one core, wherein the cavity plate and the core plate can be moved relative to each other in such a way that they can be moved back and forth between an open position and a closed position. In the closed position, the core is arranged in the cavity so that a molding space is formed into which the plasticized melt is introduced. An inner contour of the cavity thus corresponds at least in sections to the outer contour of the molded part to be produced, while an outer contour of the core corresponds at least in sections to the inner contour of the molded part to be produced. In the open position, however, the core is not arranged in the cavity so that the solidified molded part can be removed from the injection molding tool.

Furthermore, a typical injection molding tool has a neck ring that serves to precisely position the core in the cavity during the closed position and closes off the molding space. The neck ring is positioned between the cavity plate and the core plate in such a way that it complements the arrangement of cavity and core. The inner contour of the neck ring corresponds to a section of the outer contour of the molded part to be produced and thus also forms part of the molding space for the plasticized melt.

The section of the molded part can also be, for example, a threaded section of a molded part that can only be demolded due to undercuts if the molding tool element used for this purpose, i.e. the neck ring, has a multi-part design. For this purpose, the neck ring typically consists of two so-called neck jaws, which are in contact with each other in the closed position and close off the molding space. In the open position of the injection molding tool, however, the neck jaws can be moved apart so that the manufactured molded part can be removed.

To produce a molded part, the neck jaws of the neck ring are therefore first brought into contact with each other and then the core is arranged in the cavity so that a closed molding space is created that can withstand the injection pressure of the plasticized melt. This arrangement is a closed position of the injection molding tool within the meaning of the present invention. Once the melt has solidified sufficiently, the neck jaws are moved apart again and the core is moved out of the cavity so that the molded part can be removed. This arrangement is an open position of the injection molding tool within the meaning of the present invention.

The aforementioned process steps, which describe a manufacturing cycle of a molded part, are typically carried out within a few seconds, so that a manufacturing cycle is repeated many times within a very short time. During each manufacturing cycle, small particles of the molding compound may remain in the tool, in particular in gaps between the tool elements of the tool that do not come into direct contact with the melt, and these may become clogged over time.

Such a gap is located in particular between the neck ring and the cavity or core plate or between the neck jaws of the neck ring and is designed in such a way that although it does not allow any melt to escape from the molding space when the tool is in the closed position, it does serve to vent the molding space. Clogging of this gap therefore means that, in the medium or long term, air can no longer escape from the molding space and the injection molding process is impaired.

It is therefore necessary to clean the injection molding tool, especially the gaps between the tool elements. However, manual cleaning is cumbersome and leads to long downtimes of the injection molding tool.

It is already known from the prior art to alternate the manufacturing cycles of an injection molding process with cleaning cycles in which the neck jaws of the neck ring are arranged in a cleaning position. In the cleaning position, there is a gap between the neck jaws that is larger than a gap in the closed position, but smaller than a gap in the open position, so that melt can also penetrate into the gap between the neck jaws in the cleaning position. In other words, the molding space is specifically extended, i.e. overmolded, so that any particle residues that have accumulated in the gap between the neck jaws come into contact with the plasticized melt and are removed from the tool together with the resulting molded part. The molded part that was produced in the cleaning cycle is then discarded. However, the process steps themselves do not have to be interrupted for any length of time, as the cleaning cycles are similar to the manufacturing cycles, apart from the larger gap in the cleaning position compared to the closed position. Manual cleaning is not necessary.

According to the state of the art, the neck jaws are arranged in the cleaning position by reducing the closing force with which the neck jaws are pressed together in the closed position for the cleaning position, so that the neck jaws are pressed slightly apart due to the injection pressure of the plasticized melt and the melt can penetrate between them. However, varying the clamping force so that melt can penetrate between the neck jaws is complex to implement in terms of process technology and leads to damage to the tool more quickly. In addition, a separate sealing element must be used to ensure that no melt can escape from the gap between the neck jaws.

For cleaning the gap between the neck ring and the cavity or core, there is also no solution in the state of the art apart from the embodiments described.

### SUMMARY

The present invention is therefore based on the problem of providing an injection molding tool with a cleaning function or a cleaning method for an injection molding tool, in which automated cleaning takes place without complex process controls.

The problem is solved by an injection molding tool of the type mentioned at the beginning, the injection molding tool has at least one spacer element which can be arranged in the injection molding tool in such a way that a movement of the at least two tool elements from the open position in the direction of the closed position is only permitted by the spacer element up to a cleaning position, which lies between the open position and the closed position, and a further movement of the at least two tool elements in the direction of the closed position is prevented by the spacer element, is permitted by the spacer element and further movement of the at least two tool elements in the direction of the closed position is prevented by the spacer element, wherein in the cleaning position the at least two tool elements and the spacer element form at least one section of an extended molding space for receiving a plasticized melt.

According to the invention, a further movement of the tool elements towards each other into the closed position beyond the cleaning position is thus blocked by a spacer element, so that an extended molding space is created which has a larger volume compared to the molding space in the closed position and covers areas which do not come into contact with melt during the normal manufacturing cycles. The spacer element can be movably arranged in the injection molding tool in such a way that, on the one hand, it can block the movement of the tool elements in the cleaning position if the injection molding tool is to be cleaned in a cleaning cycle, but, on the other hand, it does not hinder the movement of the tool elements if they are to be moved to the closed or open position in order to produce a molded part in a manufacturing cycle. In the simplest case, the spacer element is therefore positioned manually in the injection molding tool when cleaning is required.

However, no special process control of the tool elements is required for the injection molding tool according to the invention.

The spacer element has both a blocking function with regard to the movement of the tool elements and a sealing function to seal the molding space.

In one embodiment, the spacer element is arranged directly in a gap between the tool elements in the cleaning position and/or the spacer element has a sealing element which is arranged in or at a gap between the tool elements in the cleaning position in order to seal the molding space. However, it is understood that the spacer element does not necessarily have to come into contact with the plasticized melt. Whether the spacer element or the sealing element of the spacer element comes into contact with the plasticized melt depends on how much melt is introduced into the extended molding space.

If only one sealing element of the spacer element is arranged in or at the gap between the tool elements, a blocking element of the spacer element is arranged in an area of the tool in which further movement of the tool elements towards each other can be prevented. This can, for example, be a drive that drives the movement of the tool elements. A drive for the neck jaws includes, for example, so-called slide bars, to which the neck jaws are connected in such a way that the neck jaws are moved by a movement of the slide bars. In one embodiment, the blocking element of the spacer element can therefore also be arranged between the slide bars in such a way that a movement of the slide bars is blocked from a certain point that corresponds to the cleaning position of the neck jaws.

Preferably, however, the spacer element is both a sealing element and a blocking element in one and is arranged directly in the gap between the tool elements in such a way that it is in contact with both tool elements.

In one embodiment, the injection molding tool comprises as tool elements a cavity plate with at least one cavity, a core plate with at least one core and at least one neck ring, the neck ring being arranged between the cavity plate and the core plate as viewed on a tool axis, the cavity plate, the core plate and the neck ring being movable relative to one another in such a way that in the open position the core is not arranged in the cavity so that the molded part can be removed, in the closed position the core is arranged in the cavity so that the molding space is formed by the cavity, the core and the neck ring, and in the cleaning position the core is arranged at least partially in the cavity so that the extended molding space is formed by the cavity, the core, the neck ring and the spacer element.

It is understood that the spacer element can basically be arranged between all tool elements in the cleaning position, depending on where cleaning is required.

In one embodiment, the spacer element is positioned between the tool elements manually. Alternatively, the spacer element can also be arranged automatically between the tool elements using appropriate grippers or similar.

In another embodiment, the spacer element is connected to the cavity plate or the core plate and can be actuated in such a way that, in the cleaning position, the spacer element extends essentially vertically from a surface of the cavity plate or the core plate in the direction of the tool axis up to the neck ring or between neck jaws of the neck ring, the cavity plate or the core plate preferably having a recess in which the spacer element is completely accommodated in the closed position of the injection molding tool.

In other words, the spacer element is automatically positioned between the tool elements, for example between the cavity or core plate on the one hand and the neck ring on the other and/or between the neck jaws of the neck ring, by moving the cavity plate or core plate in the cleaning position. There is no need to arrange the spacer element manually. In addition, the spacer element is connected to the cavity or core plate in such a way that it can be controlled so that it is not arranged between the tool elements in the closed position.

In particular, the cavity plate or the core plate can also have a drive with which the spacer element can be moved out of the recess of the cavity plate or the core plate in the open position, so that the spacer element is arranged between the tool elements in the cleaning position. For example, the spacer element can be designed as a pin that can be lowered into the recess of the cavity plate or the core plate so as not to hinder contact between the tool elements in the closed position.

In a further embodiment, the neck ring is one of the at least two tool elements and the cavity plate with the cavity or the core plate with the core is another of the at least two tool elements, so that in the cleaning position a gap is formed between the neck ring on the one hand and the cavity or the core on the other hand by the spacer element, the spacer element preferably having an opening for the core to pass through.

In a further embodiment, the neck ring has two neck jaws, one of the neck jaws being one of the at least two tool elements and the second neck jaw being another of the at least two tool elements, so that in the cleaning position a gap is formed between the two neck jaws of the neck ring by the spacer element.

It is understood that a combination of the last two embodiments described is also possible, so that a gap is formed between the neck ring on the one hand and the cavity or core plate on the other and a gap is formed between the neck jaws of the neck ring by the spacer element. In this way, all contaminated areas can be cleaned in one cleaning cycle.

In particular, in one embodiment, the spacer element is then designed such that a first section of the spacer element in the cleaning position is arranged in a gap between the neck ring on the one hand and the cavity or the core on the other hand, and a second section of the spacer element is arranged in a gap between the neck jaws of the neck ring, wherein preferably the first and second sections of the spacer element are formed in one piece, wherein particularly preferably the spacer element is a pin or a stamped-bent part, wherein, if the spacer element is a stamped-bent part, the second section is produced by bending from the first section.

The openings in the spacer element described in connection with another embodiment for inserting the core can also be produced particularly easily using a stamping process. In this way, the spacer element can be produced cost-effectively overall, so that costs are saved in comparison to solutions that require complex processes.

A spacer element in the form of a pin is understood to be a component which has a large length compared to its cross-section, for example an elongated cylinder or a cuboid. In this embodiment, the pin can either be arranged so that it only creates a distance between the neck ring on the one hand and the cavity or core plate on the other, or a distance between the neck jaws of the neck ring, or alternatively the pin extends both between the neck jaws of the neck ring and between the cavity plate and the core plate.

In a further embodiment, the spacer element is designed such that, in the cleaning position, a first spacer element or a first section of the spacer element is arranged in a first end section of the gap between the neck jaws and a second spacer element or a second section of the spacer element is arranged in a second end section of the gap, which is opposite the first end section. Due to the even distribution of the spacer elements in the gap, the closing force is transmitted evenly so that a gap with a constant gap dimension is formed.

In a further embodiment, the cavity plate has a plurality of cavities and the core plate has a plurality of cores, wherein the injection molding tool further has a plurality of neck rings, wherein a neck ring is assigned to a cavity and a core, wherein the spacer element is designed and can be arranged in such a way that it extends over at least two adjacent neck rings in the cleaning position, wherein preferably the spacer element has a plurality of openings through which the cores of the core plate extend.

If the cavities and cores are arranged in rows and columns, for example, all the neck rings in one of the rows or columns can be covered by a spacer element and the neck rings in another row or column can be covered by a further spacer element. It is understood that the number of openings in the spacer element corresponds to the number of neck rings or cores that are covered by the spacer element.

In particular in combination with the embodiment in which the spacer element is intended to create a gap between the neck jaws of the neck ring as well as between the neck ring on the one hand and the cavity or core plate on the other, the embodiment described above offers the advantage that by arranging a spacer element, corresponding gaps for cleaning are created simultaneously in several arrangements of cavity, core and neck jaws. It is therefore not necessary, for example, to arrange a spacer element between each pair of neck jaws of the neck rings in a separate step.

In a further embodiment, the cavity plate also has a plurality of cavities and the core plate has a plurality of cores, the injection molding tool further having a plurality of neck rings each with two neck jaws, two neck jaws of a neck ring being assigned to a cavity and a core, wherein the spacer element is designed and can be arranged such that in the cleaning position it extends between two neck jaws of two adjacent neck rings, so that in the cleaning position the spacer element is in contact with both neck jaws of one neck ring as well as in contact with the two neck jaws of the adjacent neck ring. In other words, a one-piece spacer element or a one-piece section of the spacer element creates a gap suitable for cleaning between two neck jaws of neighboring neck rings, in that one section of the spacer element is in contact with the neck jaws of one neck ring and another section of the spacer element is in contact with the neck jaws of the neighboring neck ring.

In a further embodiment, the spacer element is designed such that it is held between the tool elements in the cleaning position by a magnetic force. It is understood that the spacer element and/or the tool elements have corresponding magnetic properties for this purpose. This simplifies the arrangement of the spacer element between the tool elements.

In a further embodiment, the tool elements have at least one recess corresponding to the spacer element, in which a section of the spacer element is arranged in the cleaning position. This improves the sealing properties of the spacer element.

The problem underlying the invention is further solved by a cleaning method for an injection molding tool, the method comprising the following steps:
a. Providing an injection molding tool according to any one of claims 1 to 12,
b. Arrangement of the spacer element between the at least two tool elements,
c. Moving the tool elements relative to one another into a cleaning position so that the tool elements are brought into contact with the spacer element, wherein movement of the tool elements relative to one another beyond the cleaning position is prevented by the spacer element, wherein the tool elements and the spacer element form at least a portion of an extended molding space for receiving a plasticized melt,
d. Filling the extended molding space with the plasticized melt,
e. Moving the tool elements to the open position so that the molded part can be removed from the injection molding tool.

Filling the molding space in step d. does not necessarily take place in such a way that the entire extended molding space is filled with the melt. This means that the melt does not necessarily come into contact with the spacer elements. Whether the melt comes into contact with the spacer elements depends on how much melt is introduced into the extended molding space.

The problem underlying the invention is further solved by an injection molding process for producing a molded part with an injection molding tool according to one of the embodiments described above, wherein the injection molding process has at least one manufacturing cycle and at least one cleaning cycle, which are carried out successively, wherein the cleaning cycle corresponds to the cleaning method described above, wherein the manufacturing cycle differs from the cleaning cycle in that no spacer element is arranged between the tool elements and the tool elements are brought into contact with one another in step c. are brought into contact with one another in the closed position, so that at least one section of the molding space is formed by the at least two tool elements and not by the spacer element.

It is understood that a number of manufacturing cycles can also run in succession before a cleaning cycle is initiated. The number of manufacturing cycles compared to cleaning cycles can, for example, be adapted to the molding compound used so that cleaning only takes place when it is necessary.

In one embodiment, a closing force with which the tool elements are brought into contact with the spacer element in the cleaning cycle is adjusted compared to a closing force with which the tool elements are brought into contact with each other in the manufacturing cycle. Preferably, the clamping force in the cleaning cycle is reduced compared to the clamping force in the manufacturing cycle.

### BRIEF DESCRIPTION OF THE DRAWINGS

Further advantages, features and possible applications of the present invention will become clear from the following description of preferred embodiments. Identical components are provided with identical reference signs.

FIG. 1 shows a schematic, three-dimensional overall view of an embodiment of the injection molding tool according to the invention.

FIG. 2 shows a schematic section of a cross-section through the embodiment of the injection molding tool according to the invention shown in FIG. 1 along the mold axis.

FIG. 3 shows a schematic representation of a molded part that was produced in the cleaning cycle using the injection molding tool according to the invention.

FIG. 4a shows a three-dimensional section of a schematic representation of the embodiment shown in FIG. 1.

FIG. 4b shows a three-dimensional section of a schematic representation of the embodiment shown in FIG. 1.

FIG. 5a shows a three-dimensional representation of a first embodiment of the spacer element for the injection molding tool according to the invention.

FIG. 5b shows an enlargement of the spacer element shown in FIG. 5a.

FIG. 5c shows the spacer element shown in FIGS. 5a and 5b in an installed state in the injection molding tool.

FIG. 6a shows a three-dimensional representation of a second embodiment of a spacer element for the injection molding tool according to the invention, which is also shown in FIGS. 4a and 4b.

FIG. 6b shows an enlargement of the spacer element shown in FIG. 6a.

FIG. 6c shows the spacer element shown in FIGS. 6a and 6b in an installed state in the injection molding tool.

FIG. 7a shows a schematic section of a neck jaw of an embodiment of the injection molding tool according to the invention, in which the spacer element shown in FIGS. 5a to 5c is installed.

FIG. 7b shows a schematic section of a neck jaw of an embodiment of the injection molding tool according to the invention, in which the spacer element shown in FIGS. 6a to 6c is installed.

FIG. 8a shows a pair of neck jaws in the open position.

FIG. 8b shows a pair of neck jaws in the closed position.

FIG. 8c shows a pair of neck jaws in the cleaning position according to the embodiment shown in FIGS. 5a to 5c.

FIG. 8d shows a pair of neck jaws in the cleaning position according to a third embodiment of the injection molding tool according to the invention.

FIG. 9 shows a schematic structure of a fourth embodiment of the injection molding tool according to the invention.

FIG. 10a shows a schematic structure of a fifth embodiment of the injection molding tool according to the invention.

FIG. 10b shows a section of a cross-section of the embodiment shown in FIG. 10a along the tool axis.

### DETAILED DESCRIPTION

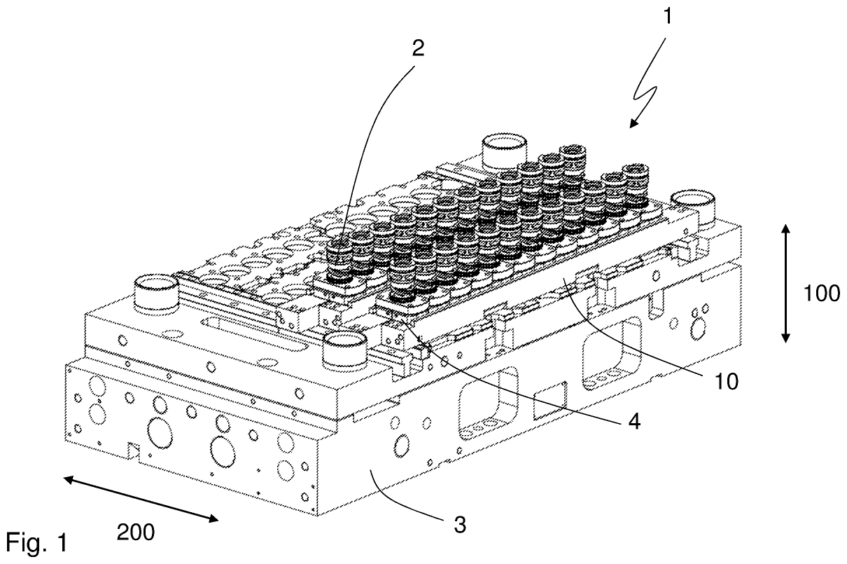

The injection molding tool 1 shown in FIG. 1 comprises a cavity plate 2 with a plurality of cavities 2a and a core plate 3 with a plurality of cores 3a and a plurality of neck rings 4 for producing a molded part 8. The cavities 2a, cores 3a and neck rings 4 are arranged in rows and columns on the cavity plate 2 or the core plate 3.

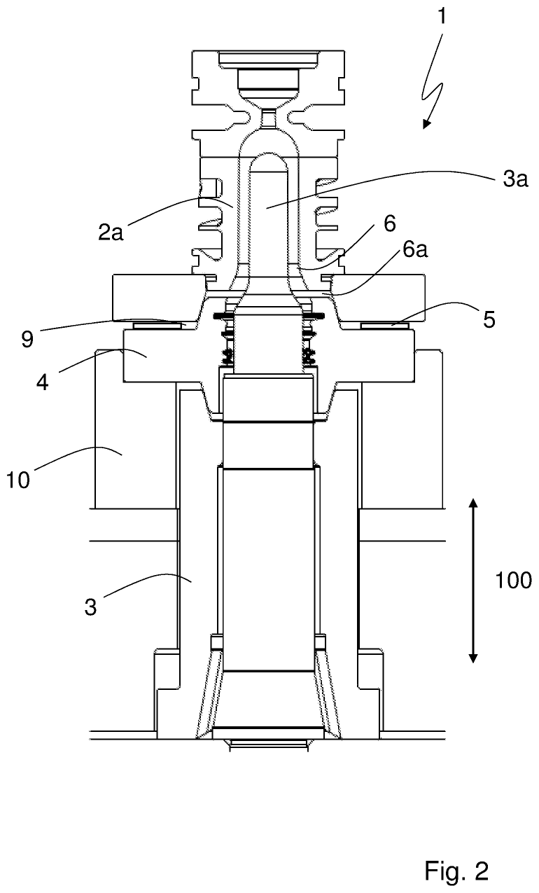

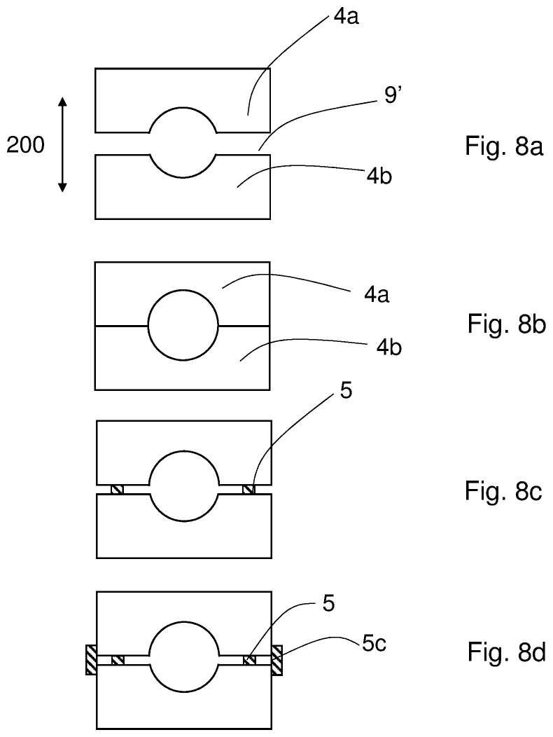

The cavity plate 2 and the core plate 3 can be moved back and forth along the tool axis 100 relative to each other between a closed position, which is shown in FIGS. 1 and 2, and an open position. Furthermore, each neck ring 4 has two neck jaws 4a, 4b which can be moved back and forth along a direction 200 on slide bars 10 to form a closed molding space 6 (see FIG. 8b) or to enable demolding of the molded part 8 (see FIG. 8a).

As can be seen in particular in FIG. 2, a core 3a is arranged in a cavity 2a in the closed position. The neck ring 4 or the neck jaws 4a, 4b each enclose a core 3a in the closed position and establish a connection to the cavity 2a. Together, the pair of neck jaws 4a, 4b, the cavity 2a and the core 3a in the closed position form a molding space 6 for receiving a plasticized melt. An inner contour of the pair of neck jaws 4a, 4b and the cavity 2a corresponds to an outer contour of the molded part 8 to be produced and an outer contour of the core 3a corresponds to an inner contour of the molded part 8 to be produced.

To produce a molded part 8, the plasticized melt is pressed into the molding space 6 in the arrangement described. As soon as the melt has solidified sufficiently, the pair of neck jaws 4a, 4b is moved apart along the direction 200 and the core 3a is moved out of the cavity 2a so that the molded part 8 can be removed. If several such manufacturing cycles are carried out in succession, dirt particles will accumulate over time, particularly in the gap 9 between the neck ring 4 and the cavity plate 2 and the gap 9′ between the neck jaws 4a, 4b of the neck ring 4.

In order to enable cleaning of the injection molding tool 1 according to the invention, it is therefore provided that in a cleaning cycle, in a cleaning position which, viewed along the tool axis 100, lies between the open position and the closed position, a spacer element 5 is arranged both in a gap 9 between the neck ring 4 and the cavity 2a of the cavity plate 2 and in a gap 9′ between the neck jaws 4a, 4b of the neck ring 4.

The arrangement of the spacer element 5 in the injection molding tool 1 blocks the tool elements cavity plate 2 with cavity 2a, neck ring 4 and neck jaws 4a, 4b of the neck ring 4 from moving towards each other beyond the cleaning position. This creates an extended molding space 6a, which is formed by the cavity 2a, the core 3a, the neck jaws 4a, 4b of the neck ring 4 and the spacer element 5. If plasticized melt is introduced into this extended molding space 6a, both the gap 9 between cavity 2a of the cavity plate 2 and neck ring 4 and the gap 9′ between the neck jaws 4a, 4b are filled with the plasticized melt. The original molding space 6 is overmolded so that an outer contour of the neck ring 4 also contributes to the inner contour of the manufactured molded part 8.

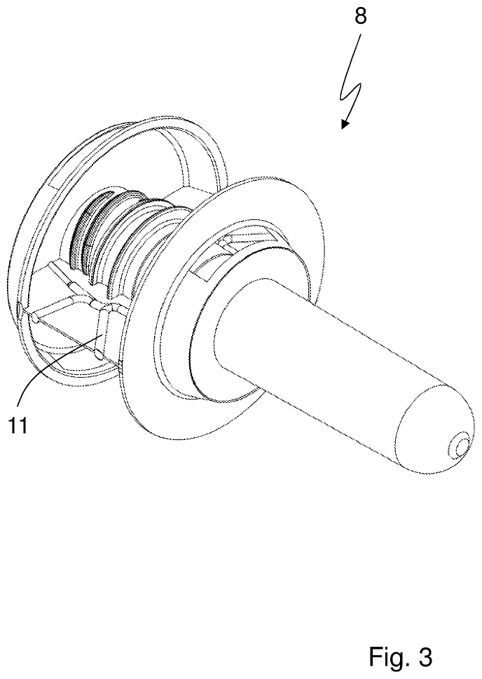

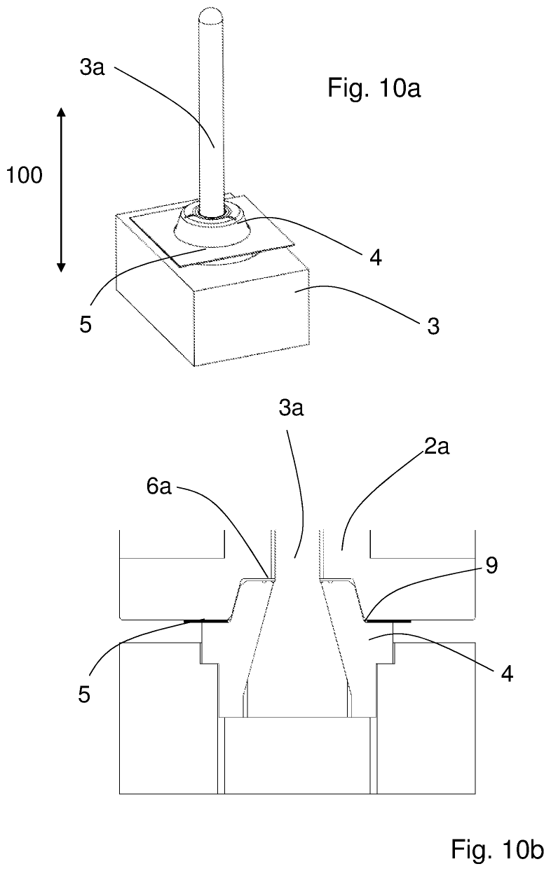

A molded part 8 that was produced in such a cleaning cycle of the injection molding tool 1 is shown in FIG. 3. It can be seen that, in addition to the inner contour of the cavity 2a and the neck jaws 4a, 4b and the outer contour of the mold core 3a, the molded part 8 also has other sections that correspond to the inner contour of the gaps 9, 9′ or the outer contour of the neck ring 4. In these gaps 9, 9′, for example, venting ducts 11 are provided, which serve to vent the molding space 6 and do not come into contact with the plasticized melt during a normal manufacturing cycle. However, during the cleaning cycle or in the cleaning position of the injection molding tool 1, the gaps 9, 9′ are widened so that melt can penetrate and the ducts and gaps are thus cleaned. It is understood that this is a description of a particular embodiment. As explained above, in another embodiment, the spacer element 5 can, for example, also be arranged only between the neck ring 4 and the cavity 2a of the cavity plate 2 (see, for example, FIGS. 10a and 10b) or only between the neck jaws 4a, 4b of the neck ring 4. Furthermore, the spacer element 5 can also be arranged, for example, between the slide bars 10 on which the neck jaws 4a, 4b are arranged in order to move them in the direction 200.

In the injection molding process according to the invention, manufacturing cycles are alternated with cleaning cycles, whereby the number of manufacturing cycles after which a cleaning cycle is required depends in particular on the material being processed.

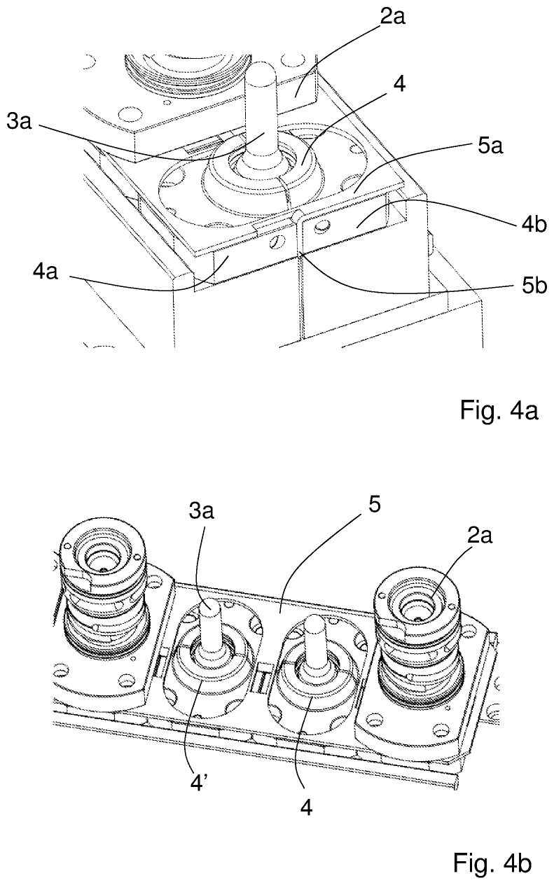

The detailed design of the spacer element 5 and its arrangement options in the injection molding tool 1 are described below, particularly with regard to FIGS. 4a to 9.

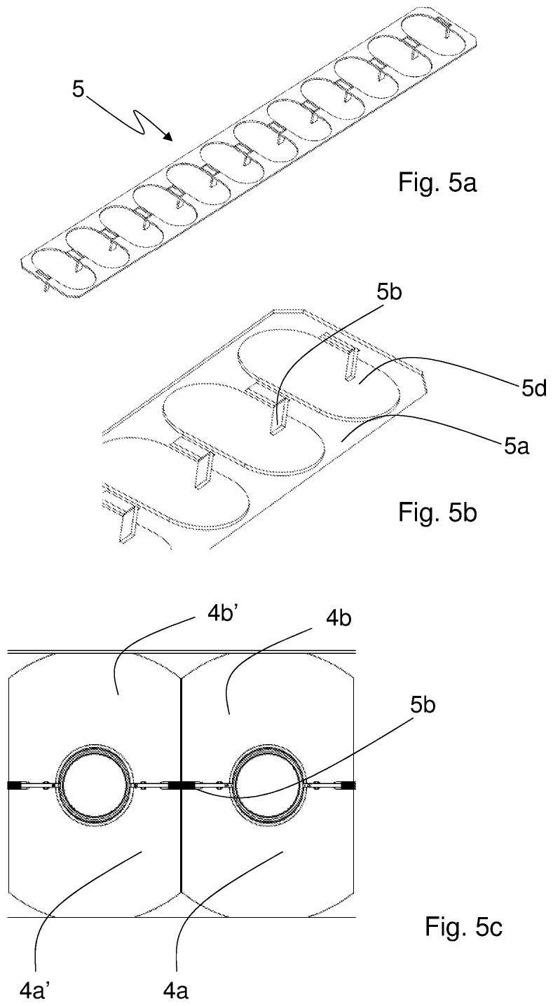

In a first embodiment of the spacer element 5 shown in FIGS. 5a to 5c, the spacer element is designed as a stamped-bent part such that it has a first section 5a and a second section 5b, wherein the second section 5b is produced by bending the first section 5a. As can be seen in particular in FIG. 4a, the first section 5a of the spacer element 5 is arranged in the cleaning position between the cavity 2a of the cavity plate 2 and the neck jaws 4a, 4b of the neck ring 4, while the section 5b of the spacer element 5 is arranged between the neck jaws 4a, 4b of the neck ring 4. The second section 5b of the spacer element thus extends essentially in the direction of the tool axis 100 from the surface of the first section 5a into the gap 9′ between the neck jaws 4a, 4b.

The spacer element 5 is further designed in such a way that it has a plurality of openings 5d, through each of which a core 3a of the core plate 3 extends. As a result, the spacer element 5 is arranged in the injection molding tool 1 in such a way that it extends over several adjacent neck rings 4, 4′, which are arranged in a row (see e.g. FIG. 4b). If the spacer element 5 is arranged in the injection molding tool 1 for cleaning the injection molding tool 1 manually, for example, the arrangement of a spacer element 5 is sufficient to form an extended molding space 6a in a plurality of arrangements of cavity 2a, core 3a, and neck jaws 4a, 4b.

As can be seen from FIG. 5c, the second section 5b of the spacer element 5 is also designed such that it extends over two adjacent neck rings 4 so that it is both in contact with two neck jaws 4a, 4b of one neck ring 4 and in contact with the neck jaws 4a′, 4b′ of the adjacent neck ring 4.

In order to produce a uniform gap 9′ between the neck jaws 4a, 4b, the first section 5a of the spacer element 5 has a plurality of second sections 5b, so that in each case two adjacent second sections 5b are arranged in a first end section 9a′ and a second end section 9b′ of the gap 9′.

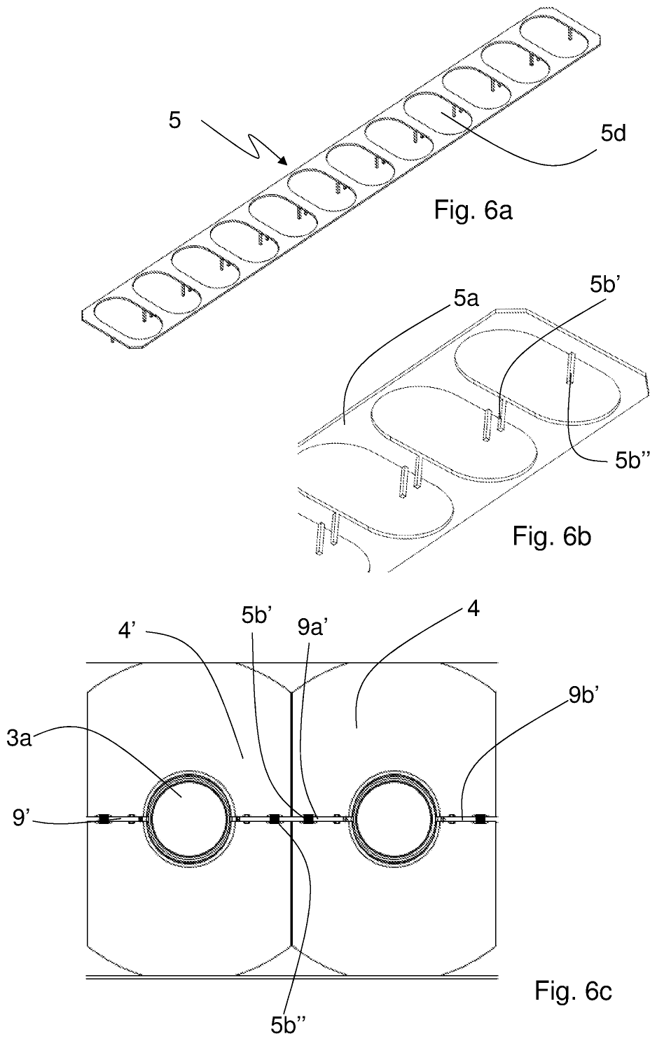

An alternative embodiment for the spacer element 5 is shown in FIGS. 6a to 6c. This embodiment of the spacer element 5 differs from the embodiment shown in FIGS. 5a to 5c in that a single second section 5b of the spacer element is formed in several parts. If FIGS. 5c and 6c are compared, it can be seen that in the second embodiment of the spacer element 5, two sections 5b′, 5b″ of the second section 5b extend into the gap 9′ between the neck jaws 4a, 4b. Otherwise, the design and arrangement of the spacer element 5 is identical to the previously described embodiment, whereby the second sections 5b′, 5b″ can be produced, for example, by casting or welding on the first section 5a.

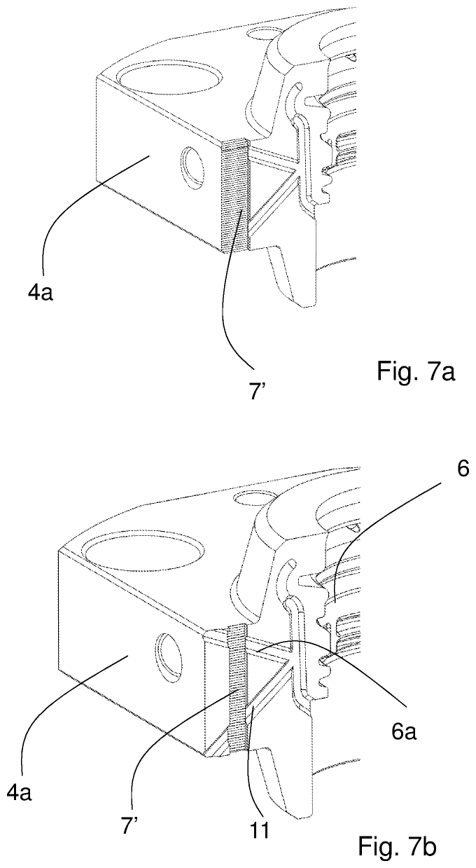

FIGS. 7a and 7b show that the neck jaws 4a, 4b or even just one of the neck jaws 4a, 4b can have a recess 7′ corresponding to the second section 5b of the spacer element 5 in order to increase the sealing properties of the spacer element 5 and to ensure that no melt can escape from the extended molding space 6a. For example, the venting ducts 11 are also closed by the spacer element 5.

In addition to the blocking function between the tool elements 2, 3, 4, 4a, 4b, the spacer element 5 also has a sealing function in order to tightly seal the extended molding space 6a. It is understood that venting of the extended molding space 6a is nevertheless ensured.

The sealing function can either be achieved by the same element 5 which also achieves the blocking function (see FIG. 8c) or the spacer element 5 can have an additional sealing element 5c which seals the gap 9′ between the neck jaws 4a, 4b and/or the gap 9 between cavity 2a of the cavity plate 2 and neck ring 4 (see FIG. 8d).

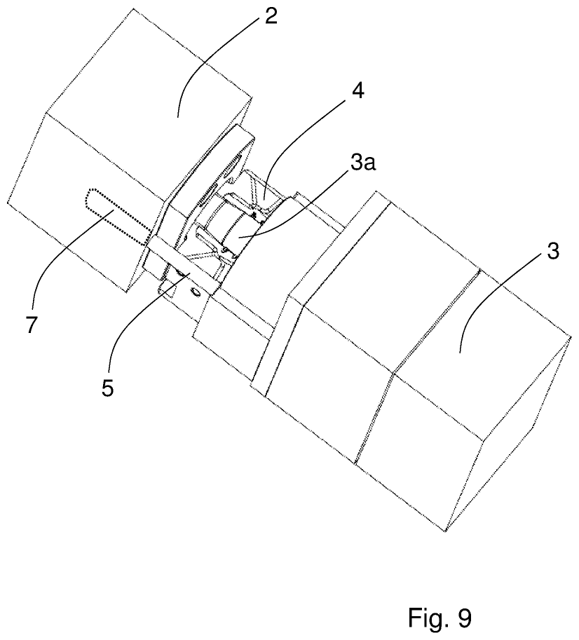

Finally, FIG. 9 shows an alternative to the manual arrangement of the spacer element 5 in the injection molding tool 1. In this embodiment, the cavity plate 2 has a recess 7 in which the spacer element 5 is completely accommodated in the closed position of the cavity plate 2, core plate 3 and neck ring 4 so as not to hinder the normal manufacturing process of the molded part 8 in the molding space 6. If the injection molding tool 1 needs to be cleaned, the spacer element 5 can be moved out of the recess 7 to form the extended molding space 6a. The spacer element 5 is thus automatically positioned between the tool elements cavity plate 2, core plate 3 and the neck rings 4a, 4b of the neck ring. There is no need to arrange the spacer element 5 manually.

The embodiment of the injection molding tool 1 according to the invention shown in FIGS. 10a and 10b differs essentially from the other embodiments in that the neck ring 4 is not multi-part, but single-part. The spacer element 5 is therefore only used to create a gap 9 between the cavity 2a of the cavity plate 2 and the neck ring 4, which is part of the extended molding space 6a.

### LIST OF REFERENCES

1 Injection molding tool
2 Cavity plate
2a Cavity
3 Core plate
3a Core
4, 4° neck ring
4a, 4b, 4a′, 4b′ Neck jaws
5 Spacer element
5a First section of the spacer element
5b Second section of the spacer element
5b′ First section of the spacer element
5b″ Second section of the spacer element
5c Sealing element
5d Opening
6 Molding space
6a Extended molding space
7, 7 Recess
8 Molded part
9, 9′ Gap
9a′ First end section of the gap
9b′ Second end section of the gap
10 Slide bars
11 Ventilation duct
100 Tool axis
200 Opening direction of the neck jaws

1. An injection molding tool for producing at least one molded part in a molding space, wherein the injection molding tool has at least two tool elements which can be moved relative to one another between an open position and a closed position, wherein in the closed position the molding space is at least partially enclosed by the at least two tool elements and wherein in the open position a molded part produced in the molding space is removed from the injection molding tool, wherein the injection molding tool has at least one spacer element, which can be arranged in the injection molding tool in such a way that a movement of the at least two tool elements from the open position in the direction of the closed position is only permitted by the spacer element up to a cleaning position which lies between the open position and the closed position and a further movement of the at least two tool elements in the direction of the closed position is prevented by the spacer element, wherein in the cleaning position the at least two tool elements and the spacer element form at least one section of an extended molding space for receiving a plasticized melt.

2. The injection molding tool according to claim 1, wherein the spacer element is arranged in a gap between the two tool elements in the cleaning position and/or wherein the spacer element has a sealing element which is arranged in or at a gap between the two tool elements in the cleaning position.

3. The injection molding tool according to claim 1, wherein the injection molding tool comprises as tool elements a cavity plate with at least one cavity, a core plate with at least one core and at least one neck ring, the neck ring being arranged between the cavity plate and the core plate as viewed on a tool axis, the cavity plate, the core plate and the neck ring being movable relative to one another in such a way that in the open position the core is not arranged in the cavity, so that the molded part can be removed, in the closed position the core is arranged in the cavity, so that the molding space is formed by the cavity, the core and the neck ring, and in the cleaning position the core is arranged at least partially in the cavity, so that the extended molding space is formed by the cavity, the core, the neck ring and the spacer element.

4. The injection molding tool according to claim 3, wherein the spacer element is connected to the cavity plate or the core plate and can be actuated in such a way that the spacer element in the cleaning position extends essentially vertically from a surface of the cavity plate or the core plate in the direction of the tool axis up to the neck ring or between neck jaws of the neck ring, and
wherein the cavity plate or the core plate preferably has a recess in which the spacer element is completely accommodated in the closed position of the injection molding tool.

5. The injection molding tool according to claim 3, wherein the neck ring is one of the at least two tool elements and the cavity plate with the cavity or the core plate with the core is another of the at least two tool elements, so that in the cleaning position a gap is formed by the spacer element between the neck ring on the one hand and the cavity or the core on the other hand, the spacer element preferably having an opening for the core to pass through.

6. The injection molding tool according to claim 3, wherein the neck ring has two neck jaws, and
wherein one of the neck jaws is one of the at least two tool elements and the second neck jaw is another of the at least two tool elements, so that in the cleaning position a gap is formed between the two neck jaws of the neck ring by the spacer element.

7. The injection molding tool according to claim 5, wherein the neck ring has two neck jaws,
wherein one of the neck jaws is one of the at least two tool elements and the second neck jaw is another of the at least two tool elements, so that in the cleaning position a gap is formed between the two neck jaws of the neck ring by the spacer element,
wherein the spacer element is designed such that a first section of the spacer element in the cleaning position is arranged in a gap between the neck ring on the one hand and the cavity or the core on the other hand and a second section of the spacer element is arranged in a gap between the neck jaws of the neck ring,
wherein preferably the first and second sections of the spacer element are formed in one piece,
wherein particularly preferably the spacer element is a pin or a stamped-bent part, and
wherein, if the spacer element is a stamped-bent part, the second section is produced by bending from the first section.

8. The injection molding tool according to claim 6, wherein the spacer element is designed such that, in the cleaning position, a first spacer element or a first section of the spacer element is arranged in a first end section of the gap between the neck jaws and a second spacer element or a second section of the spacer element is arranged in a second end section of the gap, which is opposite the first end section.

9. The injection molding tool according to claim 7, wherein the cavity plate has a plurality of cavities and the core plate has a plurality of cores,
wherein the injection molding tool further has a plurality of neck rings,
wherein a neck ring is assigned to a cavity and a core,
wherein the spacer element is designed and can be arranged in such a way that it extends over at least two adjacent neck rings in the cleaning position, and
wherein preferably the spacer element has a plurality of openings through which the cores of the core plate extend.

10. The injection molding tool according to claim 8, wherein the cavity plate has a plurality of cavities and the core plate has a plurality of cores,
wherein the injection molding tool further has a plurality of neck rings each with two neck jaws,
wherein two neck jaws of a neck ring are assigned to a cavity and a core, and
wherein the spacer element is designed and can be arranged in such a way that, in the cleaning position, it extends between two neck jaws of two adjacent neck rings, so that in the cleaning position the spacer element is in contact with both neck jaws of one neck ring as well as in contact with the two neck jaws of the adjacent neck ring.

11. The injection molding tool according to claim 1, wherein the spacer element is designed such that it is held in the cleaning position by a magnetic force between the tool elements.

12. The injection molding tool according to claim 1, wherein the tool elements have at least one recess corresponding to the spacer element, in which recess a portion of the spacer element is arranged in the cleaning position.

13. A cleaning method for an injection molding tool comprising the steps:
a. Providing an injection molding tool according to claim 1,
b. Arrangement of the spacer element between the at least two tool elements,
c. Moving the tool elements relative to one another into a cleaning position, so that the tool elements are brought into contact with the spacer element, wherein movement of the tool elements relative to one another beyond the cleaning position is prevented by the spacer element, and wherein the tool elements and the spacer element form at least a portion of an extended molding space for receiving a plasticized melt,
d. Filling the extended molding space with the plasticized melt, and
e. Moving the tool elements into the open position so that the molded part can be removed from the injection molding tool.

14. An injection molding method for manufacturing a molded part with an injection molding tool according to claim 1, wherein the injection molding method comprises:
at least one manufacturing cycle and at least one cleaning cycle which are carried out successively,
wherein the at least one cleaning cycle, includes:
i. arrangement of the spacer element between the at least two tool elements,
ii. moving the tool elements relative to one another into a cleaning position, so that the tool elements are brought into contact with the spacer element, wherein movement of the tool elements relative to one another beyond the cleaning position is prevented by the spacer element, and wherein the tool elements and the spacer element form at least a portion of an extended molding space for receiving a plasticized melt,
iii. filling the extended molding space with the plasticized melt, and
iv. moving the tool elements into the open position so that the molded part can be removed from the injection molding tool,
wherein the manufacturing cycle differs from the cleaning cycle in that no spacer element is arranged between the tool elements and the tool elements are brought into contact with each other in step ii are brought into contact with one another in the closed position, so that at least one section of the molding space is formed by the at least two tool elements and not by the spacer element.
